(19) United States
(12) Patent Application Publication
(10) Pub. No.: US 2021/0269607 A1
(43) Pub. Date: Sep. 2, 2021

(54) POLYMER COMPOSITION

(71) Applicant: Michael John FLAHERTY, Warrington (GB)

(72) Inventor: Michael John FLAHERTY, Warrington (GB)

(21) Appl. No.: 17/260,818

(22) PCT Filed: Jul. 18, 2019
(86) PCT No.: PCT/GB2019/052015

§ 371 Date: Jan. 15, 2021

(30) Foreign Application Priority Data
Jul. 18, 2018 (GB) 1811764.8

(51) Int. Cl. C08J 5/24; C08L 67/02; C08L 29/14; C08L 5/00; C08K 3/26; C08K 3/34; C08L 91/00; C08K 5/00; A01N 25/10; B01J 3/00; A01N 27/00; A01M 1/20

(52) U.S. Cl. CPC C08J 5/249; C08L 67/02; C08L 29/14; C08L 5/00; C08K 3/26; C08K 3/34; A01N 65/08; C08K 5/0058; A01N 25/10; B01J 3/008; A01N 27/00; A01M 1/2055; C08K 2003/265; C08L 91/00

(57) ABSTRACT

A method of impregnating a polymer composition with an active compound or composition using liquid carbon dioxide, in order for the active compound or composition to be later released from the polymer composition gradually over a period of time. The polymer composition may comprise polybutylene succinate and pores and/or cavities into which the active compound or composition can be introduced by the method. The method involves exposing the polymer composition to carbon dioxide and the active compound or composition under increased pressure. The polymer composition may be used to form an article for use in repelling or attracting insects, for example wearable insect repellent articles or lures for insect traps. Polymer compositions suitable for use in the method, and articles comprising said polymer compositions and active compounds or compositions are also described. A method of attracting or repelling insects is also described.

### FIELD

The present invention relates to polymer compositions and methods of impregnating said polymer compositions with active compounds. In particular the invention relates to the use of such polymer compositions and impregnation methods for producing insect attractant or repellent articles.

### BACKGROUND

Insects cause problems for human activities in many different ways. Some of the most problematic cases are where biting insects such as mosquitos spread diseases such as sleeping sickness, the zika virus, malaria and dengue fever to humans and animals. Efforts have been made to repel such insects from humans and/or animals using repellent chemicals such as essential oils, for example citronella. Efforts have also been made to produce wearable articles such as wrist bands treated with such essential oils and other active agents. However, these efforts have achieved little real success in repelling biting insects due to the short time that such wearable articles release the active agents and/or the low concentrations the active agents are released in. Biting insects may also adversely affect the health of economically important animals such as livestock, including high value animals such as thoroughbred racehorses.

Other cases where insects adversely affect human activities are in arboriculture where certain insects such as pine weevil can proliferate in pine tree plantations and cause severe damage to pine trees, particularly to saplings. This leads to high economic losses for the operator of the tree plantation and may potentially restrict the supply of timber if this problem is not addressed and such insects continue to spread and proliferate. Known methods have not been successful in properly controlling these insects, particularly in the important breeding season of such insects which often coincides with the new growth of saplings in the spring.

Traps for such insects which rely on using insect attractants to lure the insects into a trap in order to kill the insect have been shown to be only effective for a short period of time whilst the attractant active agents are released from a substrate. Once the attractant has all been released from such a substrate then the attractant has to be replenished in the trap. This is usually impractical or costly for the operator of a large tree plantation over a period of the year when the insect breeding season occurs (which can vary and be unpredictable).

Therefore there remains a need for improved materials and methods for the sustained release of active agents, such as insect repellents and/or attractants, in order to address these problems caused by particular species of insects.

### SUMMARY OF THE INVENTION

It is one aim of the present invention, amongst others, to provide a polymer composition and a method of impregnating a polymer composition with an active compound that addresses at least one disadvantage of the prior art, whether identified here or elsewhere, or to provide an alternative to existing polymer compositions and methods. For instance it may be an aim of the present invention to provide a polymer composition which releases an active compound over a desired period of time, for example a period of time greater than one week.

According to aspects of the present invention, there is provided a polymer composition and methods as set forth in the appended claims. Other features of the invention will be apparent from the dependent claims, and the description which follows.

According to a first aspect of the present invention, there is provided a method of impregnating an article with an active compound or composition, wherein the article is formed from a polymer composition comprising polybutylene succinate, the method comprising the steps of:

a) placing the article in a pressurisable vessel,

b) adding carbon dioxide to the pressurisable vessel,

c) increasing the pressure in the pressurisable vessel to above ambient pressure,

d) adding the active compound or composition to the pressurisable vessel,

e) depressurising the reactor and removing the article from the pressurisable vessel.

Suitably the steps of the method are carried out in the order step a) followed by step b) followed by step c) followed by step d) followed by step e).

Suitably in step c) the pressure in the pressurisable vessel is increased to above the critical pressure of carbon dioxide and the temperature in the pressurisable vessel is increased to above the critical temperature of carbon dioxide. Suitably the pressure and temperature are increased in the pressurisable vessel in step c) so that the carbon dioxide is in a supercritical state.

The inventor has surprisingly found that the method of this first aspect can be used to impregnate such an article formed from a polybutylene succinate (PBS) based polymer composition with an active compound (or composition) which is then able to be released over time from the article to provide a beneficial effect. For example, the article may be a wearable item and the active compound or composition may be an insect repellent compound or composition. Using the method of this first aspect, the wearable item can be effectively impregnated or loaded with such an insect repellent which is then slowly released over time to provide an insect repellent effect which lasts longer than with known wearable articles used for the same purpose.

By “impregnating an article” we mean that the polymer composition which forms the article has been loaded with the active compound or composition and said active compound or composition has entered into pores or cavities in the polymer composition, rather than just coating the outer surface of the article. Suitably the article comprises the active compound or composition both inside the polymer composition and on the surface of the article, after the method has been carried out.

By “active compound or composition” we mean any compound or composition which may have a beneficial effect. Suitably the active compound or composition has a beneficial effect on an organism, for example on insects. Suitably the active compound or composition is biologically active, suitably with respect to at least one species of insect.

The article is formed from the polymer composition. Therefore the polymer composition may provide the bulk of the article. The article may comprise or consist of the polymer composition. In some embodiments, the article comprises or consists of a sheet, strip or film of the polymer composition.

Step a) involves placing the article in a pressurisable vessel. A suitable pressurisable vessel may comprise an inlet for carbon dioxide and an inlet for adding an active compound or composition. Suitable pressurisable vessels are known in the art. The pressurisable vessel may be referred to as a reaction vessel or an autoclave.

Step b) involves adding carbon dioxide to the pressurisable vessel. Suitably the carbon dioxide is added under pressure to the pressurisable vessel, suitably using a high pressure pump. Suitably the carbon dioxide is added to the pressurisable vessel as a liquid.

Step c) involves increasing the pressure in the pressurisable vessel to above ambient pressure. Therefore step c) involves increasing the pressure to above atmospheric pressure, suitably to at least 1.5 bar, suitably at least 2 bar. Suitably in step c) the pressure is increased sufficiently for the carbon dioxide to act as a solvent for the active compound or composition and allow said active compound or composition and the carbon dioxide to penetrate into the polymer composition. The pressure may therefore vary according to the specific active compound or composition used.

In some embodiments, step c) is carried out at a pressure of from 1.5 to 5 bar, suitably from 1.5 to 3 bar, and at a temperature of from 10 to 30° C., suitably from 15 to 25° C.

In some embodiments, step c) involves increasing the pressure in the pressurisable vessel to liquefy the carbon dioxide. Liquid carbon dioxide may act as a suitable solvent for the active compound or composition and allow said active compound or composition to penetrate into the polymer composition with the carbon dioxide.

In some embodiments, step c) involves increasing the pressure and temperature in the pressurisable vessel to change the carbon dioxide into a supercritical state.

Suitably, in step c), the pressure and the temperature in the pressurisable vessel is increased to above the critical pressure of carbon dioxide and the temperature in the pressurisable vessel is increased to above the critical temperature of carbon dioxide. Suitably the pressure and temperature of the carbon dioxide are above the critical point of carbon dioxide. Supercritical carbon dioxide may act as a suitable solvent for the active compound or composition and allow said active compound or composition to penetrate into the polymer composition with the carbon dioxide.

In such embodiments, step c) is carried out at a pressure of at least 73.9 bar and at a temperature of at least 31.1° C. Suitably step c) is carried out at a pressure of from 73.9 bar to 110 bar and at a temperature of from 31.1 to 40° C.

Suitably in step c) the pressure is increased in the pressurisable vessel by adding the carbon dioxide under pressure, for example by using a high pressure pump. Therefore steps b) and c) may be carried out at the same time by this operation. Therefore the steps of the method of the first aspect may be carried out in the order step a) followed by steps b) and c) followed by step d) followed by step e).

Step d) involves adding the active compound or composition to the pressurisable vessel. Suitably the active compound or composition is added to the pressurisable vessel as a liquid. Suitably the active compound or composition is dissolved in the carbon dioxide after addition to the pressurisable vessel.

Step e) involves depressurising the reactor and removing the article from the pressurisable vessel. Suitably this involves venting the carbon dioxide from the pressurisable vessel. The carbon dioxide vented from the pressurisable vessel may be recovered and re-used. This may improve the efficiency and reduce the environmental impact of the process. Step e) may result in some of the active compound or composition remaining in the pressurisable vessel. This active compound or composition may be re-used when the process is subsequently carried out on further articles. This may also improve the efficiency and reduce the environmental impact of the process. Suitably in step e), the carbon dioxide is escapes from the polymer composition and leaves behind, inside the pores and/or cavities of the polymer composition, the active compound or composition.

Suitably after step d) and before step e), the pressurisable vessel is kept under the increased pressure of carbon dioxide for at least 10 minutes, suitably for at least 20 minutes, suitably for at least 30 minutes or for at least 45 minutes, for example for at least 1 hour.

The pressurisable vessel may be kept under the increased pressure of carbon dioxide for up to 5 hours, suitably for up to 4 hours, suitably for up to 2 hours.

The Polymer Composition

The article used in the method of this first aspect is formed from a polymer composition comprising polybutylene succinate (PBS). Suitably the polymer composition comprises pores and/or cavities into which the active compound or composition can be impregnated. The PBS may therefore comprise pores and/or cavities.

Suitably the polymer composition is a “biopolymer” composition. Suitably the polymer composition is biodegradable, suitably formed from sustainably sourced components.

Suitably the polymer composition comprises at least 30 wt % PBS, suitably at least 35 wt % PBS, suitably at least 40 wt % PBS.

Suitably the polymer composition comprises up to 90 wt % PBS, suitably up to 85 wt % PBS, suitably up to 80 wt % PBS.

Suitably the polymer composition comprises from 30 to 90 wt % PBS, suitably from 30 to 80 wt % PBS, suitably from 40 to 80 wt % PBS.

The polymer composition may comprise a structure-modifying additive. Such a structure-modifying additive may cause or increase the formation of pores and/or cavities in the polymer composition. The structure-modifying additive may be selected from any one or more of: polyvinyl acetate, a polysaccharide, calcium carbonate and talc.

A suitable polyvinyl acetate for use as such an additive in the polymer composition is Vinnex 2504 supplied by Wacker Chemie. Vinnex 2504 is suitably biodegradable when blended with PBS in the polymer composition. The polymer composition may comprise PBS and a polyvinyl acetate. The inventor has found that a polymer composition comprising PBS and a polyvinyl acetate comprises, after compounding at 145° C. and extruding into an article, pores and/or cavities which can be effectively impregnated with an active compound or composition using the method of this first aspect. This may be due to the polyvinyl acetate breaking down at said temperature to leave said pores and/or cavities in the polymer composition.

A suitable polysaccharide may be chitosan, suitably derived from shrimp shells.

A suitable calcium carbonate may be obtained from a shellfish, for example the product Oysterlean supplied by ESP Solutions which is obtained from oyster shells or Smartfill supplied by Omya which is obtained from lobster shells.

A suitable talc may be supplied by the Luzenac Group.

The structure-modifying additive may be a calcium carbonate coated with a fatty acid. Such a fatty acid may improve the biodegradation profile of the polymer composition by providing an additional food source for microbes. The fatty acid coating is typically from 0.1 to 5% by weight, for example approximately 1% of the calcium carbonate by weight. Suitable fatty acid compounds include free fatty acids and salts and esters thereof. Preferred fatty acid compounds are stearate compounds. Suitable stearate compounds include stearic acid and stearic acid salts. Suitable stearic acid salts include alkali metal, alkali earth metal and ammonium salts, for example calcium stearate. A suitable calcium carbonate coated with a fatty acid is Polcarb 60S, a stearate coated calcium carbonate.

In order to include the structure-modifying additive in the polymer composition, the structure-modifying additive and the PBS, and any other component of the polymer composition present, are blended together. Suitably the different components are thermally blended together (or melt processed). For example, a twin extruder may be used to blend the components of the polymer composition together and extrude the polymer composition. The inventor has found that a polymer composition comprising PBS and such a polysaccharide, calcium carbonate or talc may comprise, after compounding or blending at 145° C. and extruding into an article, pores and/or cavities which can be effectively impregnated with an active compound or composition using the method of this first aspect.

Suitably the polymer composition comprises at least 3 wt % structure-modifying additive, suitably at least 5 wt %, suitably at least 10 wt %, suitably at least 15 wt % structure-modifying additive.

Suitably the polymer composition comprises up to 40 wt % structure-modifying additive, suitably up to 35 wt %, suitably up to 30 wt % structure-modifying additive.

Suitably the polymer composition comprises from 10 to 40 wt % structure-modifying additive, suitably from 10 to 30 wt %, suitably from 15 to 30 wt % structure-modifying additive.

In some embodiments, the polymer composition comprises from 80 to 90 wt % PBS and from 10 to 20 wt % structure-modifying additive. In said embodiments, the structure-modifying additive is suitably calcium carbonate, suitably Smartfill.

In some embodiments, the polymer composition comprises polylactic acid (PLA). Therefore in some embodiments, the polymer composition comprises PBS and PLA, and suitably a structure-modifying additive.

Suitably the polymer composition comprises at least 20 wt % PLA, suitably at least 25 wt % PLA, suitably at least 30 wt % PLA.

Suitably the polymer composition comprises up to 55 wt % PLA, suitably up to 50 wt % PLA, suitably up to 45 wt % PLA.

Suitably the polymer composition comprises from 25 to 50 wt % PLA, suitably from 30 to 50 wt % PLA, suitably from 30 to 45 wt % PLA.

In such embodiments, the polymer composition suitably comprises from 35 to 50 wt % PBS, from 25 to 45 wt % PLA and from 10 to 30 wt % structure-modifying additive. Suitably the polymer composition comprises from 40 to 50 wt % PBS, from 30 to 40 wt % PLA and from 10 to 30 wt % structure-modifying additive. In said embodiments, the structure-modifying additive is suitably a polyvinyl acetate, suitably Vinnex 2504.

In some embodiments, the polymer composition comprises a higher proportion of PLA than PBS. In such embodiments, the polymer composition comprises PBS and PLA, and suitably a structure-modifying additive.

In such embodiments, the polymer composition suitably comprises at least 30 wt % PLA, suitably at least 35 wt % PLA, suitably at least 40 wt % PLA.

In such embodiments, the polymer composition suitably comprises up to 75 wt % PLA, suitably up to 70 wt % PLA, suitably up to 65 wt % PLA.

In such embodiments, the polymer composition suitably comprises from 30 to 75 wt % PLA, suitably from 35 to 70 wt % PLA, suitably from 40 to 65 wt % PLA.

In such embodiments, the polymer composition suitably comprises at least 5 wt % PBS, suitably at least 7.5 wt % PBS, suitably at least 10 wt % PBS.

In such embodiments, the polymer composition suitably comprises up to 50 wt % PBS, suitably up to 45 wt % PBS, suitably up to 40 wt % PBS.

In such embodiments, the polymer composition suitably comprises from 5 to 50 wt % PBS, suitably from 10 to 45 wt % PBS, suitably from 10 to 40 wt % PBS.

In such embodiments, the polymer composition suitably comprises from 10 to 45 wt % PBS, from 35 to 70 wt % PLA and from 5 to 25 wt % structure-modifying additive. Suitably the polymer composition comprises from 10 to 40 wt % PBS, from 40 to 65 wt % PLA and from 5 to 15 wt % structure-modifying additive. In said embodiments, the structure-modifying additive is suitably a polyvinyl acetate, suitably Vinnex 2504.

Suitably the polymer composition can be varied to alter the properties of the polymer composition, such as impregnation capacity, release rate, mechanical properties and biodegradation profile, according to the requirements of the particular intended use of the article. For example, if a slower release of said active compound or composition is required then a relatively high proportion of PLA can be included in the polymer composition. This is believed to provide a tighter pore structure which restricts the release of said active compound or composition.

Suitably the polymer composition has a melting point lower than 240° C., suitably lower than 220° C., suitably lower than 200° C.

Suitably the polymer composition has a melting point above 100° C., suitably above 120° C., suitably above 140° C.

Suitably the polymer composition has a melting point from 140 to 200° C. Such a melting point is favourable for the ease of processing the polymer composition whilst being resistant to the temperatures the polymer composition may be subjected to in use.

Suitably the polymer composition has a heat deflection temperature of at least 70° C., suitably of at least 80° C., suitably of at least 90° C., suitably as measured by the standard method of ASTM D648. Suitably the polymer composition has a heat deflection temperature of from 90 to 110° C., as measured by ASTM D648.

The Active Compound or Composition

In the method of this first aspect, the active compound or composition suitably comprises an essential oil derived from a plant. Essential oils derived from plants are often used to either attract or repel insects. Suitably the active compound or composition impregnated into the article is an essential oil or a mixture of essential oils.

Suitably the active compound or composition is a liquid at the operating temperatures and pressures of the method of this first aspect. Suitably the active compound or composition is a liquid above 50° C., suitably a liquid above 40° C., suitably above 30° C., suitably above 20° C. The active compound or composition being a liquid at such temperatures allows the active compound or composition to mix thoroughly and dissolve in the carbon dioxide and facilitate impregnation into the polymer composition.

In some embodiments, the active compound or composition is an insect repellent. For example the active compound or composition may comprise any one or more of lavandin oil, geranium oil and citriodiol. Suitably the active compound or composition comprises lavandin oil, geranium oil and citriodiol. Suitably the active compound or composition consists or consists essentially of lavandin oil, geranium oil and citriodiol.

In said embodiments, the lavandin oil, geranium oil and citriodiol may each be present in the active compound or composition in an amount of from 25 wt % to 50 wt %. Suitably the lavandin oil, geranium oil and citriodiol are present in the active compound or composition in approximately equal amounts, therefore in a ratio of approximately 1:1:1.

In embodiments wherein the active compound or composition comprises lavandin oil, geranium oil and citriodiol, the article may be particularly suitable for repelling mosquitos and/or horsefly.

In some embodiments, the active compound or composition may comprise nootkatone (4-α,5-Dimethyl-1,2,3,4,4α,5,6,7-octahydro-7-keto-3-isopropenylnaphthalene). In such embodiments, the article may be particularly suitable for repelling ticks.

The article impregnated with the active compound or composition by the method of this first aspect may be a wearable article for repelling insects from a human or animal, suitably wherein the active compound or composition is an insect repellent as described above. For example, the article may be a strip or band formed of the polymer composition. Such a strip may be suitable for attaching to a limb of a human or animal, for example by tying the strip around such a limb or by attaching such a strip to an animal's tail, such as a horse's tail. Alternatively the strip could be attached with an adhesive to clothing, bags, saddles, reigns etc. The strip releases the active compound or composition over time which repels target insects, such as mosquitos, from the human or animal. The active compound or composition may be selected to repel a specific insect for a specific intended circumstance and/or location of use by humans or animals.

A band formed from the polymer composition may be worn around a user's wrist in the manner of known insect repellent wearable bands.

The method of this first aspect may provide the article with an improved release profile of the active compound or composition compared to such known wearable bands or strips. For example, the levels of active compound or component released may be increased and/or may be more consistent and/or may be released for a longer period of time compared to such known wearable bands or strips, due to the effective impregnation of the polymer composition.

In some embodiments, the active compound or composition is an insect attractant. For example the active compound or composition may comprise α-pinene and/or β-pinene. Suitably the active compound or composition consists or consists essentially of α-pinene and/or β-pinene. Suitably the active compound or composition comprises α-pinene. Suitably the active compound or composition consists or consists essentially of α-pinene. In such embodiments, the article may be particularly suitable for attracting bark beetles.

In some embodiments, the active compound or composition may comprise the attractants nonanal (nonanaldehyde) and/or octanal (octanaldehyde), suitably nonanal and octanal. In such embodiments, the article may be particularly suitable for attracting bed bugs.

The article impregnated with the active compound or composition by the method of this first aspect may be a lure for an insect trap, suitably wherein the active compound or composition is an insect attractant as described above, suitably comprising α-pinene. For example, the article may be a strip formed of the polymer composition which is impregnated with an insect attractant such as α-pinene by a method of the first aspect. This strip can then be placed in an insect trap to release the active compound or composition over time and attract insects into said trap in order for the insect to be incapacitated or killed in the trap by the action of an insect pathogen. Suitable insect pathogens and insect trap designs may be known in the art. The active compound or composition may be selected to attract a specific insect for a specific intended circumstance and/or location of use. Such an insect trap may be particularly useful in combatting pests which feed on pine trees, for example pine weevils or pine beetles. In use, such an insect trap would be suitably placed near to young pine trees which pine weevils or pine beetles would normally feed upon.

The article impregnated with the active compound or composition by the method of this first aspect may comprise or consist of a film of the polymer composition. The thickness of the film may be adjusted during manufacture in order to control the length of time during which the article releases the active compound or composition. A thicker film of the polymer composition may release the active compound or composition over a longer period of time than a thinner film of polymer composition. Therefore, the thickness of the film of polymer composition may be adjusted in this manner in order to obtain a desired release time period for a specific application. In some applications, such as wearable insect repellent articles, the desired release time may be one to two weeks. In other applications, such as lures for insect traps, the desired release time may be three to six months. Therefore the film of the polymer composition used for the wearable insect repellent article may be thinner than the lure for insect traps. Suitably the polymer composition is a film with a thickness of from 350 μm to 1 mm.

In some embodiments, the polymer composition may be in the form of pellets, suitably having an average diameter of less than 5 mm, suitably having an average diameter of less than 2 mm or approximately 2 mm. Such pellets may be easier to use in some applications, for example when adding into insect traps where the amount of polymer composition impregnated with the active compound or composition can be easily controlled by the user.

In some embodiments, the active compound or composition is a plant nutrient composition, suitably comprising essential plant nutrients. In such embodiments, the plant nutrient composition is suitably released to soil on or in which the article is placed whilst the article is biodegraded into the soil. The plant nutrient composition suitably comprises nitrogen, potassium and phosphate, and suitably magnesium. A suitable plant nutrient composition may be provided by a liquid seaweed fertilizer obtained from seaweed. Such liquid seaweed fertilizers are a rich source of plant sugars, growth hormones and essential minerals. Such liquid seaweed fertilizers suitably comprise cytokinins which may benefit plants by stimulating growth protecting from frost. The resultant article may be suitable for feeding turf, commercial crops including fruit and vegetables, and a variety of other plants.

Suitably the active compound or composition is impregnated into the polymer composition so that the active compound or composition is present in an amount of at least 1 wt % relative to the polymer composition, suitably at least 2 wt %. Suitably, after the method of impregnating the article, the active compound or composition is present in an amount of up to 10 wt % relative to the polymer composition, suitably up to 7.5 wt %, suitably up to 5 wt %. Suitably the active compound or composition is present in an amount of from 1 to 5 wt % relative to the polymer composition, suitably from 2 to 5 wt %.

According to a second aspect of the present invention, there is provided an article for attracting or repelling insects, wherein the article is formed from a polymer composition comprising polybutylene succinate and wherein the polymer composition is impregnated with an active compound or composition.

The article, polymer composition and active compound of composition may have any of the suitable features and advantages described in relation to the first aspect.

The article of this second aspect may be alternatively or additionally described as comprising a polymer composition comprising polybutylene succinate, wherein the polymer composition comprises an active compound or composition within the polymer composition. Suitably the polymer composition is adapted to release the active compound or composition over a period of time, suitably over a period of time greater than one week. For example, the polymer composition suitably comprises pores and/or cavities into which the active compound or composition is impregnated/absorbed and from which the active compound or composition is released, in use.

The article may be substantially or completely formed from the polymer composition, suitably a film of the polymer composition. In some embodiments, the article may comprise additional parts or materials besides the polymer composition. For example, the article may contain additional parts which allow the article to be attached to the body of a human or animal, such as straps, adhesive strips or fasteners.

According to a third aspect of the present invention, there is provided a method of attracting or repelling insects, the method comprising the steps of:

1) forming an article from a polymer composition comprising polybutylene succinate;

2) impregnating the article with an insect attractant or repellent compound or composition according to the method of the first aspect of the present invention;

3) placing the article at a location where insects are to be attracted to or repelled from.

The article, polymer composition and method of impregnation may have any of the suitable features and advantages described above in relation to the first and second aspects.

The insect attractant or repellent may be any of the active compounds or compositions described above in relation to the first aspect.

Suitable situations and/or locations for the article to be placed in step 3) may be as described above in relation to the first aspect.

Suitably the steps of the method are carried out in the order step 1) followed by step 2) followed by step 3).

### EXAMPLE SET 1—PREPARATION OF POLYMER COMPOSITIONS

Each of the polymer compositions described below in Table 1 were formed using standard compounding and extruding equipment by adding the specified components to the compounder, mixing and heating to 145° C. in the compounder and extruding the polymer composition into films. The type of structure-modifying additive used in each polymer composition is noted in Table 1.

TABLE 1

| Polymer | PBS | PLA | Additive |
|---|---|---|---|
| composition | (wt %) | (wt %) | type - wt % |
| HDT WPL 011 | 45 | 35 | Vinnex 2504 - 20 |
| HDT WPL 012 | 50 | 30 | Chitosan - 20 |
| HDT WPL 013 | 45 | 30 | Luzenactalc - 25 |
| HDT WPL 014 | 75 | 0 | Oysterlean - 25 |
| HDT WPL 015 | 87.5 | 0 | Smartfill - 12.5 |
| HDT WPL 016 | 40 | 40 | Chitosan - 20 |
| HDT WPL 017 | 50 | 30 | Polycarb 60S - 20 |

### Examples—Heat Deflection Testing (HDT)

Heat deflection testing was carried out on the polymer compositions HDT WPL 011-017 shown in Table 1 using the standard procedure of ASTM D648.

The samples were machined into rectangular bars of 127 mm×13 mm×3 mm ready for HDT testing.

A calibrated United Instruments HDT/Vicat tester, equipped with three sample stages was used to determine the heat deflection temperature of the samples. The tests were performed according to ASTM D648 applying fibre stresses of σ=0.45 MPa for all samples. The samples were mounted on the HDT tester stages in the edgewise direction. The stages with the samples were then immersed in a heat transfer oil bath. The appropriate total mass, including the mass of the loading rod and press head (˜75 g) was added to each sample to achieve the desired stress (σ) of 0.45 MPa calculated using the equation dictated in the ASTM D648. The distance between the support stands was adjusted to 100 mm.

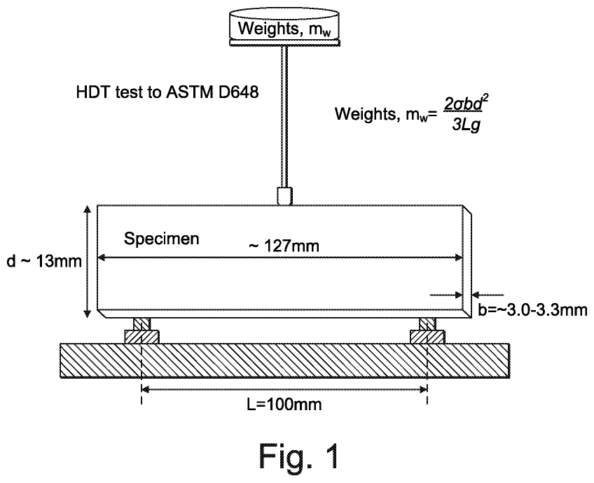

A schematic of the test arrangement is shown in FIG. 1 together with the sample geometry. The equation used to calculate the load applied is given below:

The HDT results are shown in Table 2 below.

TABLE 2

| Polymer | Individual HDT test | Average HDT result |
|---|---|---|
| composition | results (° C.)* | (° C.) |
| HDT WPL 011 | 96.8, 100.4, 101.0 | 99 |
| HDT WPL 012 | 97.2, 96.0 | 97 |
| HDT WPL 013 | 93.7, 95.8, 94.7 | 95 |
| HDT WPL 014 | 99.7, 98.4 | 99 |
| HDT WPL 015 | 100.9, 101.1 | 101 |
| HDT WPL 016 | 94.7, 94.3, 95.3 | 95 |
| HDT WPL 017 | 97.8, 94.9, 94.4 | 96 |

*Only for the samples in which the HDT values between the first two samples was greater than 1.4° C., was a third sample tested and an average of the three reported.

Each of the samples HDT WPL 011-017 showed a heat deflection test result which indicates the polymer compositions would be suitable for use outdoors in relatively high ambient temperatures. For example, each polymer composition may be suitable for use in a wearable insect repellent articles or insect traps which are both intended for use in hot climates.

### Examples—Impregnation of Polymer Compositions with Insect Repellents

A roll of film formed from polymer composition HDT WPL 011 was impregnated with an essential oil blend that contains lavandin oil, rose geranium oil and nepeta cataria oil.

Supercritical carbon dioxide (scCO₂) was used in a method for impregnating essential oils to the polymers as it may act as a low viscosity and highly diffusive carrier. Two different methods of impregnating essential oils using scCO₂ were used and then release profiles of the essential oils over time were studied.

Raw materials: Lavandin oil (Grosso), Rose Geranium oil (Pelargonium graveo/ens) and Catnip oil (Nepeta cataria) were purchased from Elixarome Ltd. A comparative polymer film formed from PLA was provided.

Sample preparation: polymer film of composition HDT WPL 011 and the comparative polymer film was divided into sections of 13.5 cm×2 cm for all trials. An essential oil blend was prepared by mixing lavandin oil, rose geranium oil and catnip oil at a 1:1:1 ratio.

Extraction trials: Extraction trial was carried out using a Thar SFC-1000 laboratory plant fitted with a 100 ml extractor and a 250 ml separator. Two independent methods were used to impregnate each sample of the polymer composition and the methods are described below:

Method 1—Continuous Flow Method

23 strips of the polymer film HDT WPL 011 (39.03 g) (called “red sheet” in the following data) or 5 strips of comparative polymer film (41.12 g) (called “collar” in the following data) were packed into a 100 ml extractor and the vessel was pressurised to 100 bar, 40° C. with a CO₂ flow at 5 g/m in. Once the extraction vessel reached 100 bar, 5% (0.25 g/min) of the essential oil blend was continuously introduced into the extractor for 60 minutes. After 60 minutes, the flow of the essential oil blend ceased and neat scCO₂ was passed through the extraction vessel for 15 minutes to remove any free (not impregnated into the polymer film) essential oil. Thereafter, the extractor was depressurized at 1 bar per 5 seconds and the polymer sample was retrieved and stored in heat sealed aluminium laminated bags.

Method 2—Stop Flow Method

27 strips of red sheet (37.68 g) of 5 strips of collar (39.06 g) were packed into a 100 ml extractor and the vessel was pressurised to 100 bar, 40° C. with a CO₂ flow at 5 g/min. Once the extraction vessel reached 100 bar, 5% (0.25 g/min) of the essential oil blend was continuously introduced into the extraction for 30 minutes. After 30 minutes, the flow of the essential oil blend and CO₂ were ceased and the extraction vessel was isolated so that the polymer sample stood in solution for a further 60 minutes. After 60 minutes, neat scCO₂ was passed through the extraction vessel for 15 minutes to remove any free essential oil. Thereafter, the extractor was depressurized at 1 bar per 5 seconds and the polymer sample was retrieved and stored in heat sealed aluminium laminated bags.

All samples of polymer were impregnated on the same day to eliminate any process variables that might occur on different days.

Establishment of release profile of essential oil: 3 strips of impregnated polymers were removed from the heat sealed aluminium bags on the day of analysis and the volatile organic compounds (VOCs) of each strip of polymer were analysed. The profile of VOCs of these samples were denoted as day 1. The strips of polymers were laid on a tray and preserved in a temperature controlled room (27° C.) for a 10 day period. Strips of red sheet were analysed on days 1, 3, 5, 8 and 10. Analysis of three independent strips of impregnated polymer would allow the elimination of any outlier.

Analysis: Essential oil (as supplied) and as blended were analysed as liquid dilution (2 μl in 1 cm³ of heptane) and 1 μl of this solution was injected into the GC-MS injector at 250° C. This was carried out to determine the principal components of the essential oil and these components were used as markers to follow the progress of the release profile.

The relative abundance of VOCs emitted by the polymer sample was analysed by Headspace Solid Phase Microextraction (HS-SPME). The procedure is described as follows.

Approximately 35 mg of polymer sample was placed into a headspace vial (20 cm³) and equilibrated for 10 minutes at 40° C. After equilibration, a 5 cm 50/30 μm Divinylbenzene/Carboxen/Polydimethylsiloaxane (DVB/CAR/PDMS) fibre was exposed in the headspace of the vial under the same conditions for a suitable period. After absorption, the fibre was retracted and desorbed for 1 minute in the GC-MS injector (250° C.). This process was carried out manually using accurate timing at all stages. Between extractions, the fibre was conditioned following the manufacturer's instructions, exposing the fibre at 270° C. for 30 minutes in a GC injector under a constant flow of hydrogen.

The peak area of the principal component of each essential oil was acquired for each sample of polymer and these provided semi-quantitative data to monitor the abundance of the principal component of each essential oil over a 10 day period.

GC-MS conditions: Analysis was carried out using an Agilent 6890 gas chromatograph coupled to an Agilent 5973 mass spectrometer (EI detector) equipped with a Zebron ZB5-MS column (30 m×0.25 mm×0.25 μm). The GC-MS system was controlled by MSD Chemstationsoftware equipped with NIST/EPA/NIH Mass Spectral Library. The carrier gas was maintained at 1 cm³.min-1helium, injector temperature was 250° C. and had a split ratio of either 2:1 (for HS-SPME analysis) or 50:1 (for analysis of liquid dilution). Mass spectra were recorded in electron impact (EI) ionization mode, scanning m/z 40 to 600 in 1 second.

Temperature programme 1—HS-SPME analysis: The temperature program was as follows: 40° C. (2.5 min hold), 5° C./min to 200° C., 10° C./min to 240° C. (5 min hold).

Temperature programme 2—Analysis of liquid dilution: The temperature program was as follows: 60° C. (1 min hold), 6° C./min to 300° C. (10 min hold).

Results: The essential oils used in the impregnation trials were analysed individually and as a blend of the three oils using HS-SPME and liquid injections. The analytical response for the principal components of the liquid injection and HS-SPME measures the volatility of the components. Thus β-cineole and linalyl acetate were identified as markers for lavendin oil; citronellol and 8-linalool for geranium oil and nepetalactone and caryophyllene for nepeta oil.

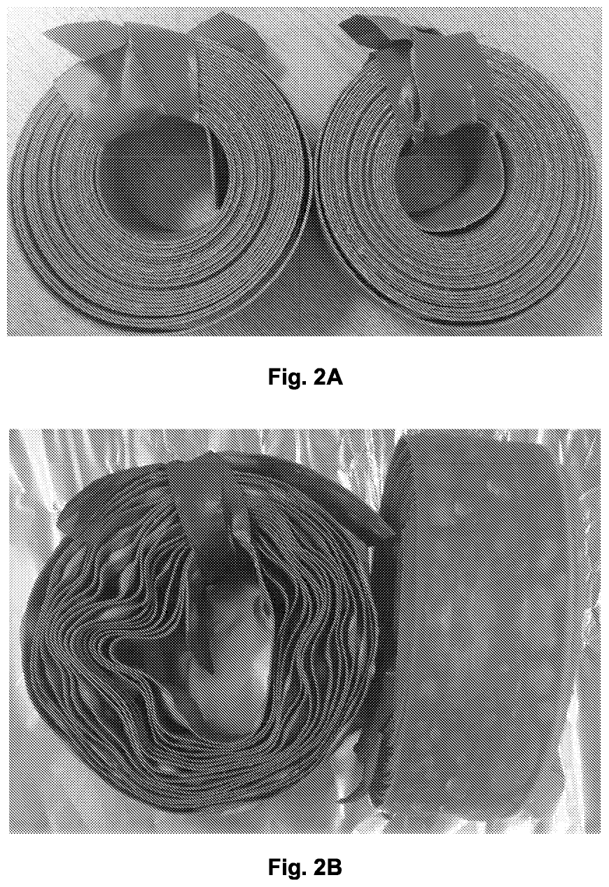

Observations from the impregnation trials: FIGS. 2A and 2B show the roll of polymer film pre- and post-impregnation. The strips of polymer obtained after the impregnation trial show that during the process, blisters have formed on the surface of the sample of polymer due to the passage of CO₂ that had penetrated through the material (FIG. 2B). After each impregnation trial, neat scCO₂ was passed through the sample of polymer in order to remove the free oil; the mass of free oil obtained in each impregnation trial as shown in Table 3. The data showed that using method 2, the mass of free oil obtained was lower and this indicated that this process had allowed the polymer to capture more essential oil blend. By stopping the CO₂ flow the oil has greater contact with the sample of polymer thus an equilibrium is established. It was noted that there was a loss to the colour of the blend of essential oil that was recovered. Analysis of the oil indicated that there were no compositional changes to the blend of essential oil and the loss of colour was due to pigments binding onto the polymer. This suggests that the oil that was recovered can be recycled for additional trials and the pigment binding is not likely to have a detrimental effect on the polymer.

TABLE 3
Mass of polymer sample loaded and mass of free
oil recovered in each impregnation trial

| | | No. of | | Mass of |
|---|---|---|---|---|
| | | strips of | Mass of | free oil |
| | Impregnation | polymer in | sample in | recovered in |
| Sample | method | extractor | extractor (g) | separator (g) |
| Red film | 1 | 23 | 39.03 | 7.82 |
| Red film | 2 | 27 | 37.68 | 3.58 |
| Collar 1 | 1 | 5 | 41.12 | 11.57 |
| Collar 2 | 2 | 5 | 39.06 | 4.71 |

### Examples—Insect Repellent Release Profiles

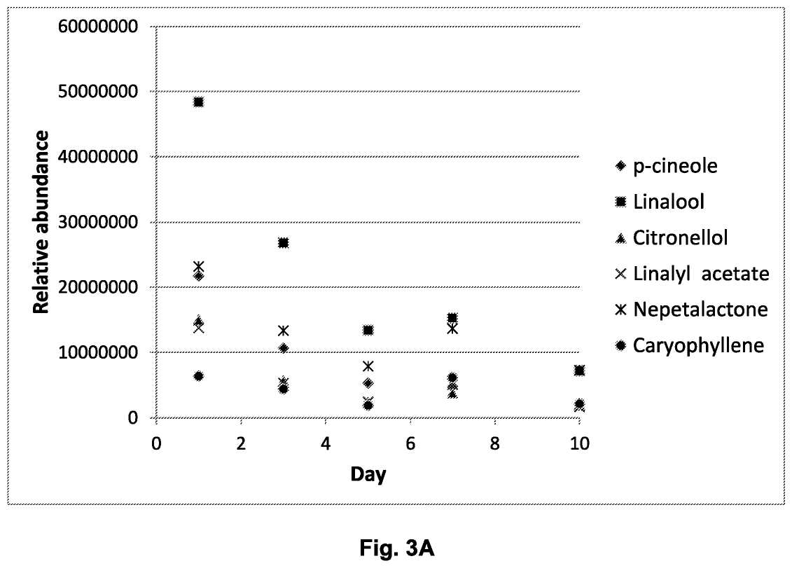

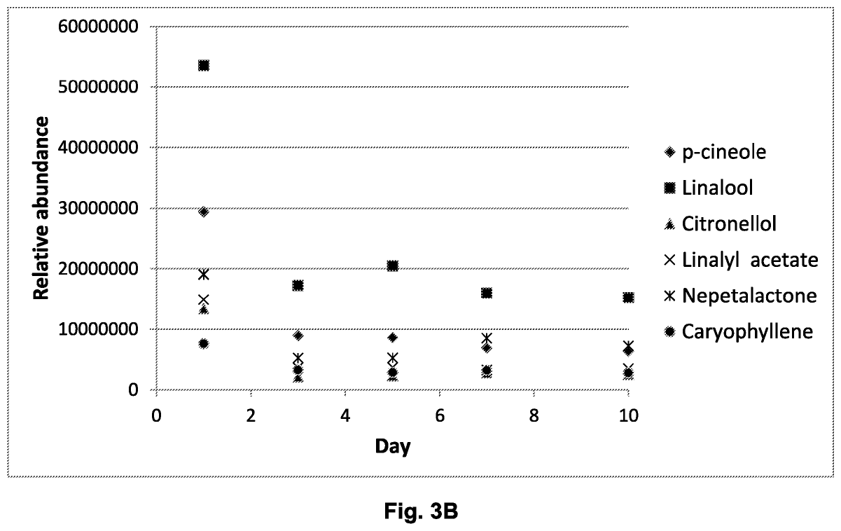

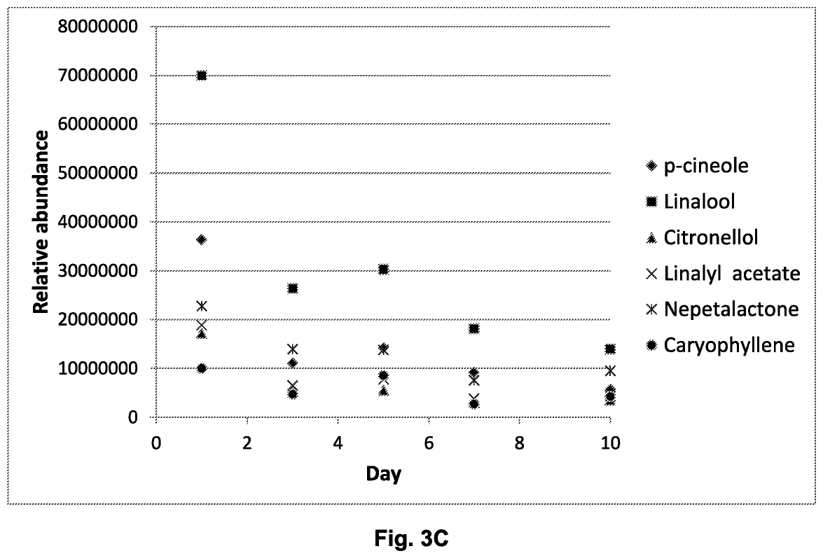

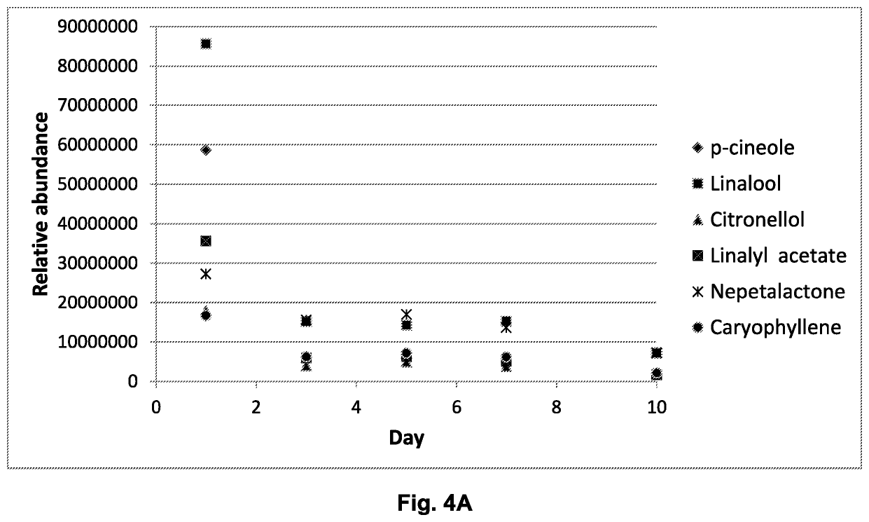

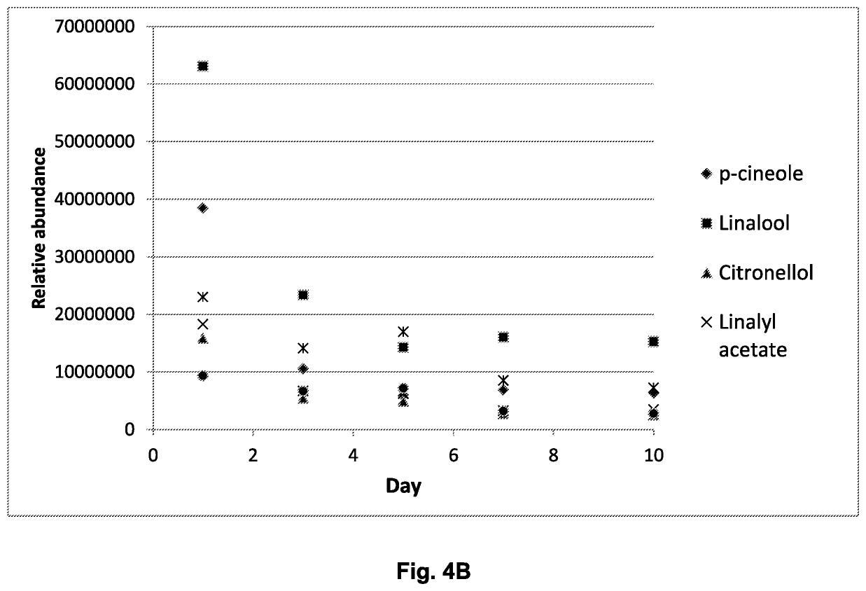

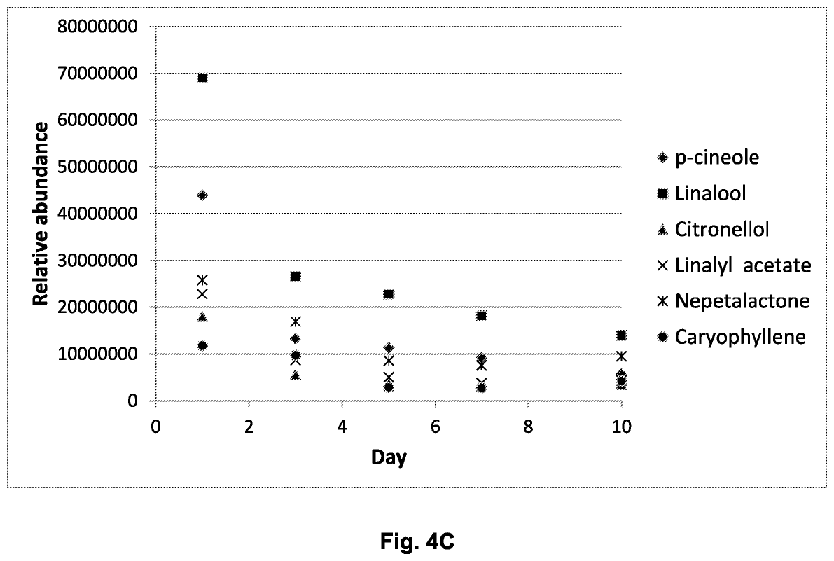

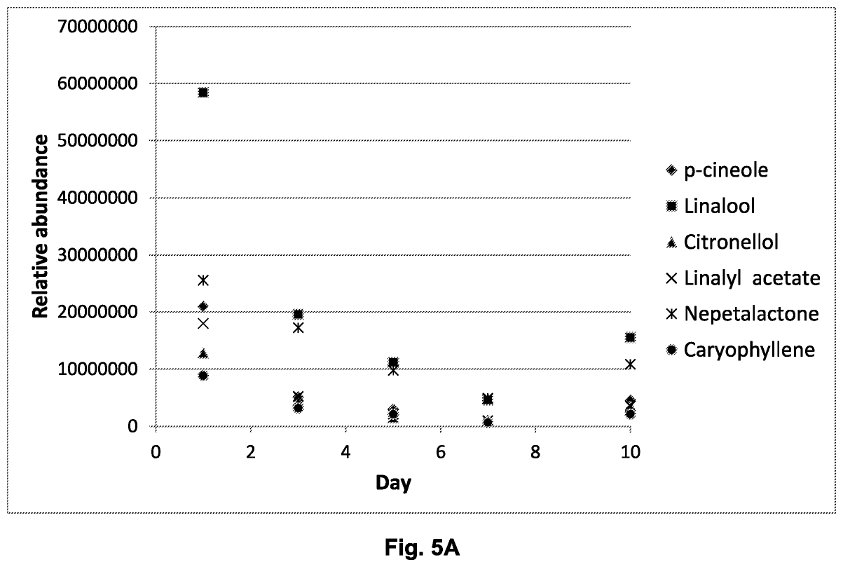

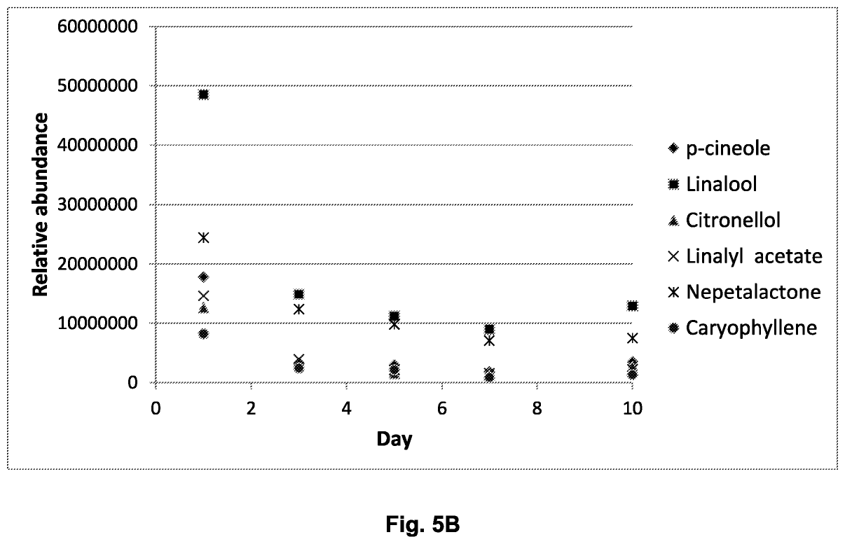

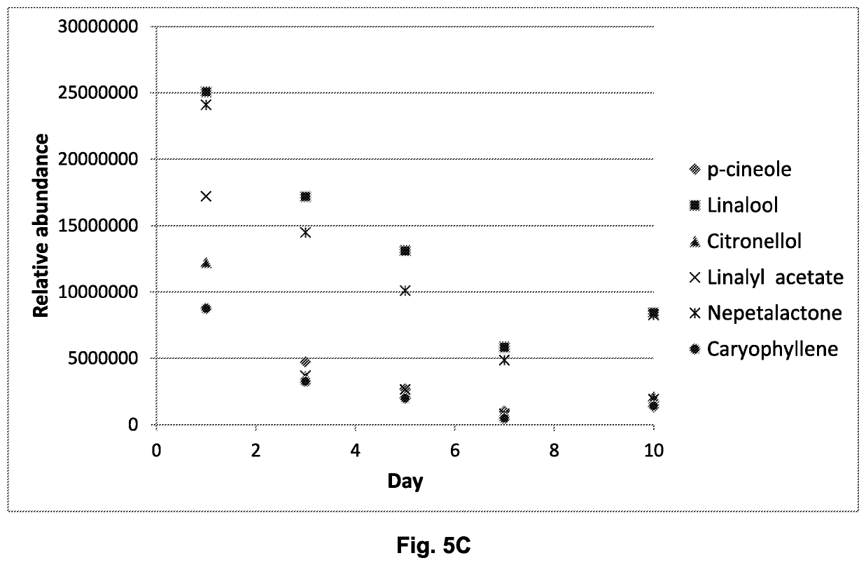

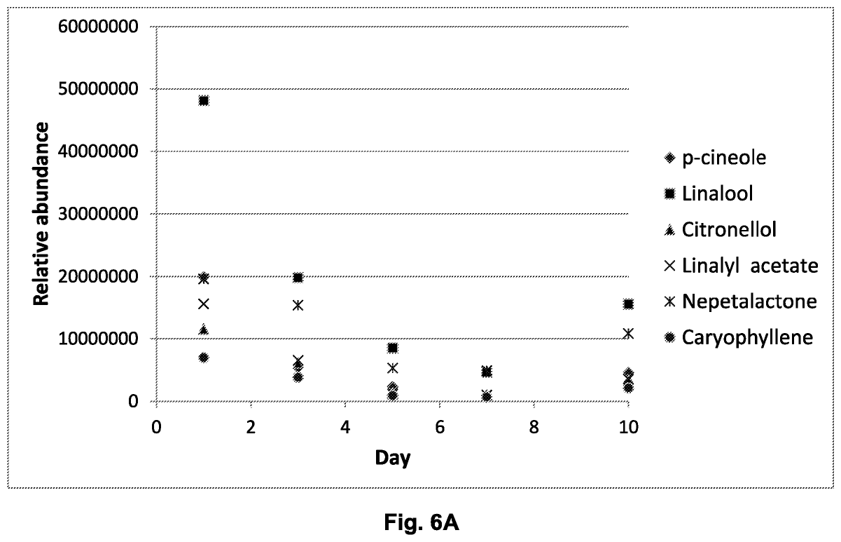

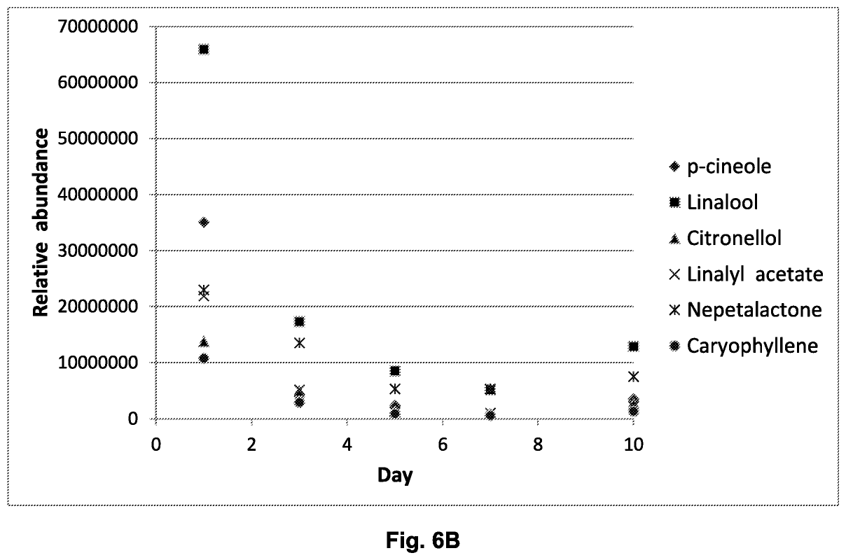

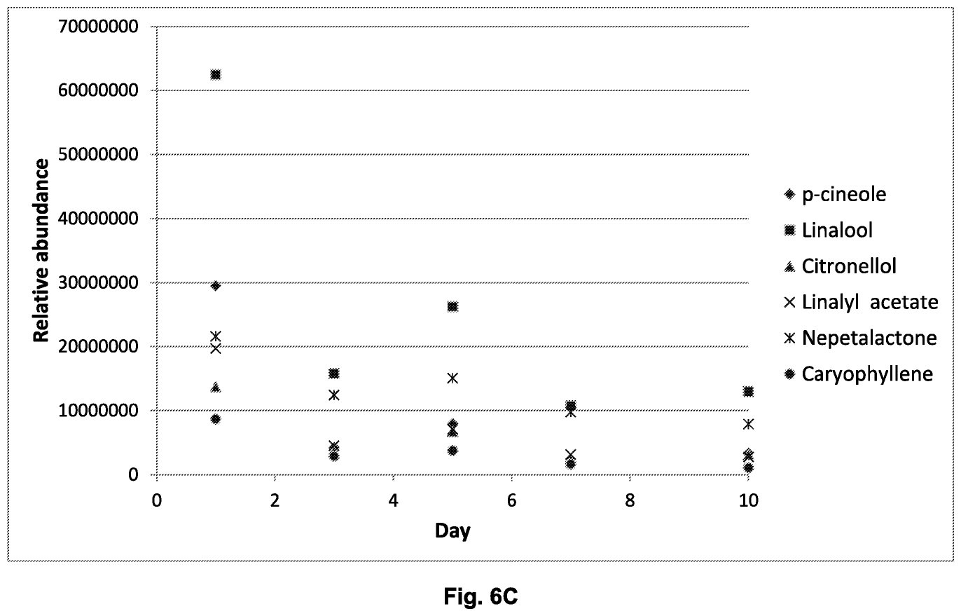

Three individual strips of impregnated polymer were preserved in a temperature controlled room and the volatile organic compounds (VOCs) of these samples were analysed over a 10-day period. The relative abundance of the selected marker compounds for each essential oil over this period was monitored. FIGS. 3-6 shows that from day 1 to day 3, there was a rapid decrease to the abundance of each selected marker compound. From day 3 to day 10, the relative abundance of each marker compounds was stable and no further decline was observed. It was noted that there was only a marginal change in the relative abundance due to a variation of analytical response. This trend was observed for all the VOCs, this was not expected as the boiling points of each VOCs differed and it was expected that some VOCs would have had experienced a greater reduction than others.

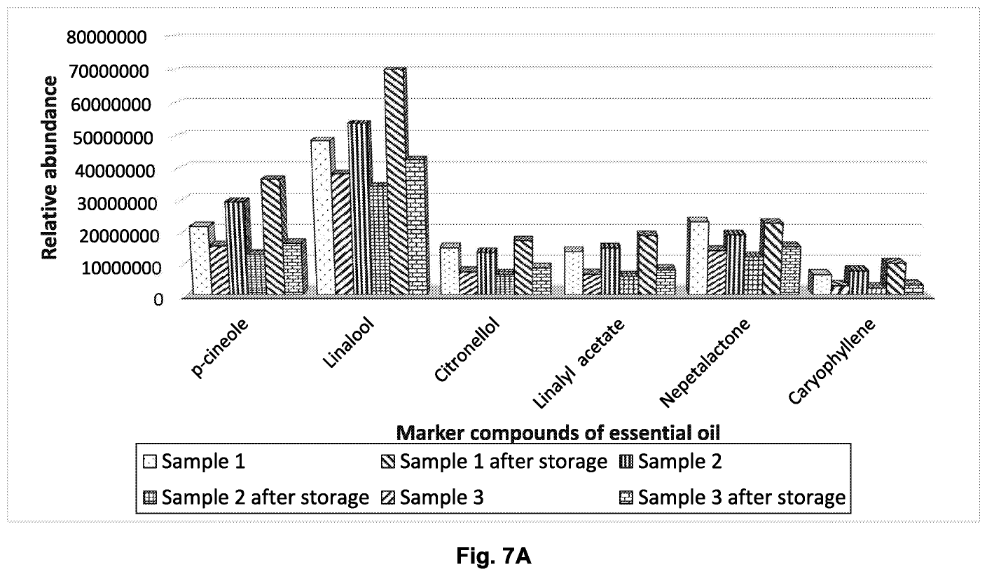

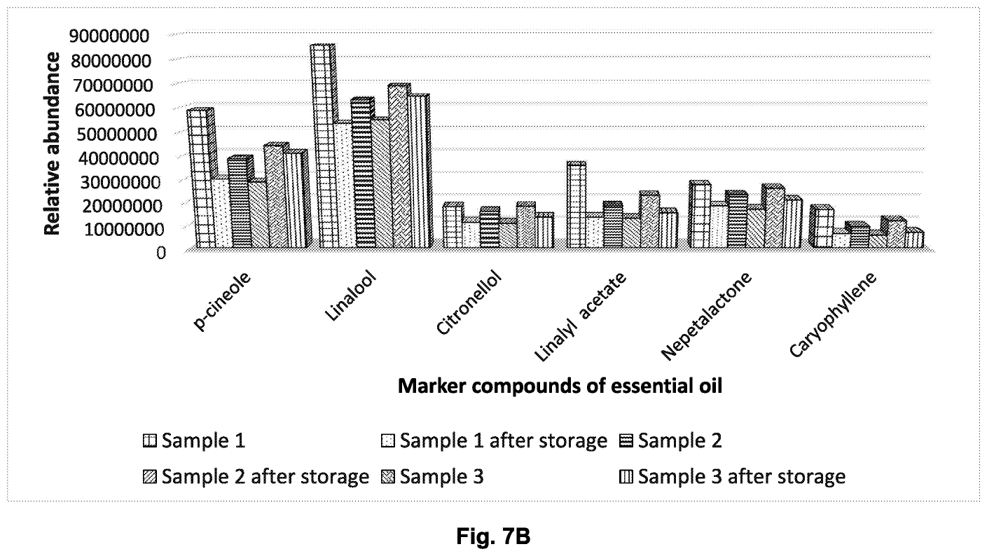

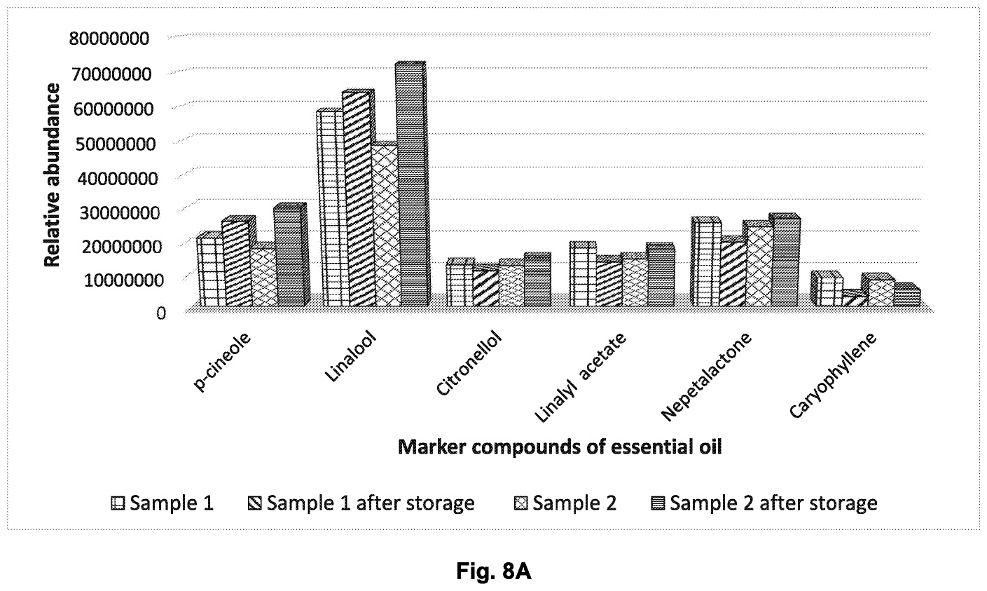

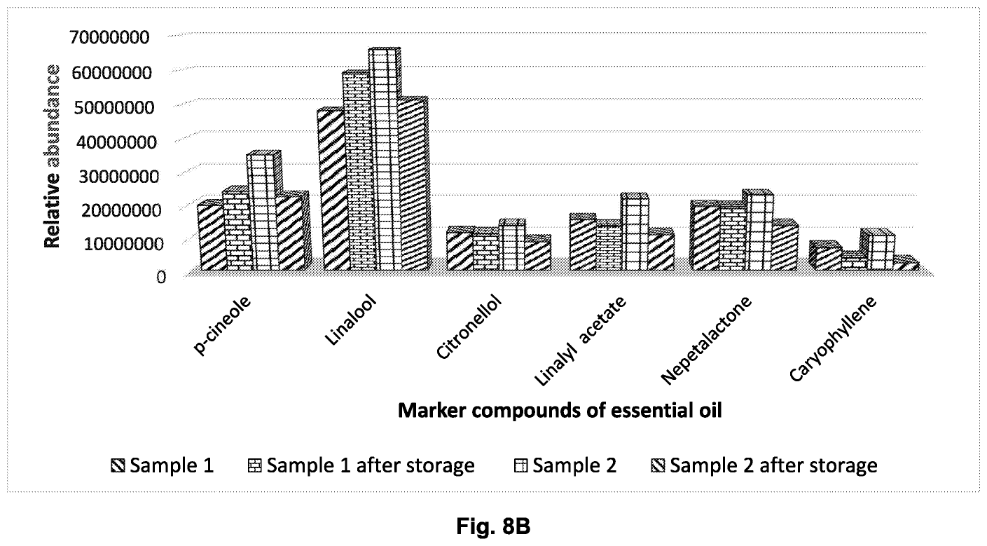

To assess the stability of the VOCs of the impregnated polymers, the strips of impregnated polymer were re-sealed in heat sealed aluminium bags and retained in a temperature controlled room. The relative abundance of the marker compounds in these strips of impregnated polymers (after prolonged storage) were compared with the strips of impregnated polymers at day 1. FIGS. 7 and 8 shows relative abundance of the marker compounds and an insignificant difference was observed. It was not known if the minor variation was due to differences in analytical response or a sample to sample variation during the impregnation trial.

Conclusions: This work has demonstrated that it was feasible to impregnate essentials oils into polymers using scCO₂. The release profile of the impregnated polymer indicated that the VOCs that were impregnated into the polymers experienced a rapid decline from day 1 to day 3. Subsequently, the abundance of these VOCs remained stable from day 3 to day 10 and shows no further reduction in level of abundance of these VOCs. The stability of the impregnated polymer that was kept in heat seal aluminum bag in a temperature controlled room indicated there was no significant decline to the VOCs and demonstrated that these impregnated polymers have a long shelf life when in suitable packaging.

### Examples—Impregnation of Polymer Compositions with Insect Attractant

A roll of film formed from polymer composition HDT WPL015 (called “red film” in the data below) and pellets of the same polymer composition (called “polymer beads” in the data below) were impregnated with pinene compounds using the following procedure and materials.

Raw materials: 100 ml of α-pinene was purchased from Sigma Aldrich.

Extraction trials: An extraction trial was carried out using a Thar SFC-1000 laboratory plant fitted with a 1 L extractor and a 250 ml separator. The samples were packed into a 1 L extractor and the vessel was pressurised to 100 bar, 35° C. with a CO₂ flow at 10 g/min. Once the extraction vessel reached 100 bar, 5% (0.50 g/min) of α-pinene was continuously introduced into the extraction for 90 minutes. After 90 minutes, the flow of essential oil and CO₂ were ceased and the extraction vessel was isolated so that the polymer sample stood in solution for a further 120 minutes. After 120 minutes, neat scCO₂ was passed through the extraction vessel for 30 minutes to remove any free oil. Thereafter, the extractor was depressurised at 1 bar per 10 seconds and the polymer sample was retrieved and stored in sealed aluminium foil pouches.

Analysis: The relative abundance of VOCs emitted by the polymer sample was analysed by Headspace Solid Phase Microextraction (HS-SPME). The procedure is described as follows.

Approximately 60 mg of polymer sample was placed into a headspace vial (20 cm³) and equilibrated for 10 minutes at 40° C. After equilibration, a 5 cm 50/30 μm divinylbenzene/carboxen/polydimethylsiloxane (DVB/CAR/PDMS) fibre was exposed in the headspace of the vial under the same conditions for a suitable period. After absorption, the fibre was retracted and desorbed for 1 minute in the GC-MS injector (250° C.). This process was carried out manually using accurate timing at all stages. Between extractions, the fibre was conditioned following the manufacturer's instructions, exposing the fibre at 270° C. for 30 minutes in a GC injector under a constant flow of hydrogen.

GC-MS conditions: Analysis was carried out using an Agilent 6890 gas chromatograph coupled to an Agilent 5973 mass spectrometer (EI detector) equipped with a Zebron ZB5-MS column (30 m×0.25 mm×0.25 μm). The GC-MS system was controlled by MSD Chemstation software equipped with NIST/EPA/NIH Mass Spectral Library. The carrier gas was maintained a 1 cm³·min⁻¹ helium, injector temperature was 250° C. and had a split ratio of either 2:1 (for HS-SPME analysis) or 50:1 (for analysis of liquid dilution). Mass spectra were recorded in electron impact (EI) ionization mode, scanning m/z 40 to 600 in 1 second. The temperature program was as follows: 40° C. (2.5 min hold), 5° C./min to 200° C., 10° C./min to 240° C. (5 min hold).

Results: Table 4 shows the mass of polymer samples loaded into a 1 L extraction vessel and the volume of free α-pinene recovered; a lower volume of α-pinene was recovered from the use of polymer beads as the material absorbed a greater volume of α-pinene.

TABLE 4
Mass of polymer sample loaded and mass of free
oil recovered in each impregnation trial

| | Mass of polymer | Mass of free |
|---|---|---|
| | packed in the | oil recovered from |
| Sample | extractor (g) | the separator (g) |
| Red film | 532.16 | 21.18 |
| Polymer beads | 603.11 | 13.47 |

The physical appearance of the recovered α-pinene after the impregnation trial showed that pigments from the polymers were extracted along with an unknown white solid. The white solid is presumably residual matter retained during the manufacture of the polymers beads, bur there is no justification for the white solids recovered from the red film trial as loose polymeric material should have been absent. The recovered α-pinene can be used for subsequent batches of impregnation trials, but the α-pinene would require filtration to remove the white solids to avoid causing mechanical problems to the delivery pump. It can be noted that if the process is scale-up to the pilot plant or commercial scale, the required treatment of the recovered α-pinene can contribute to elevating the cost of production.

Red film supplied was coiled into rolls, similar to as shown in FIG. 2, and blisters were formed on the surface of the red film during the impregnation trial as shown in FIG. 3. The formation of the blisters was due to the encapsulation of α-pinene. It was observed that this encapsulation effect was not observed in the polymers beads as the polymer beads remained in its original form after the impregnation trial was completed.

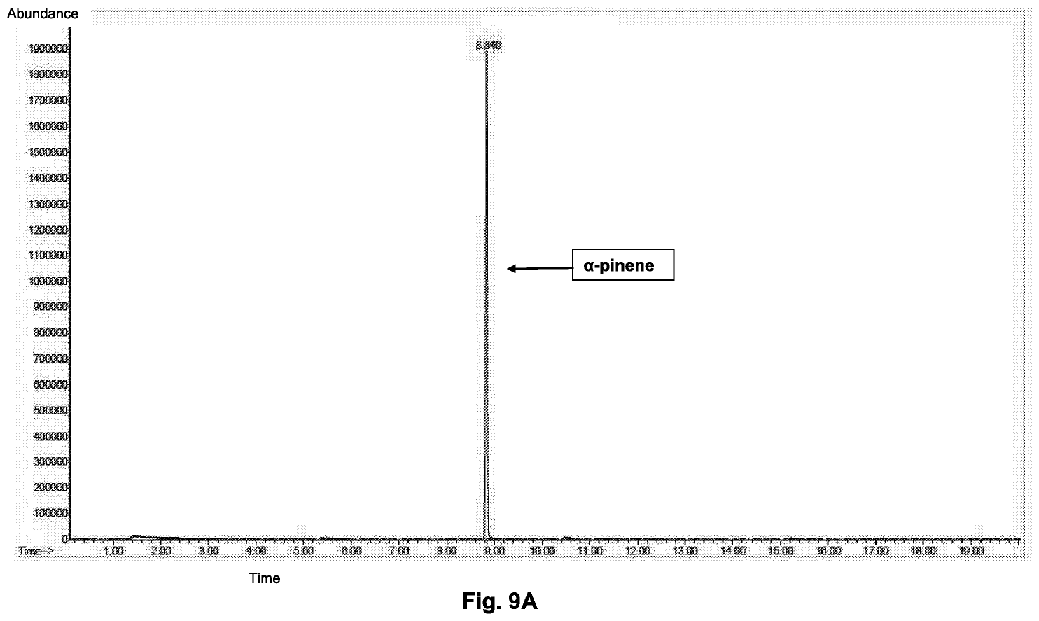

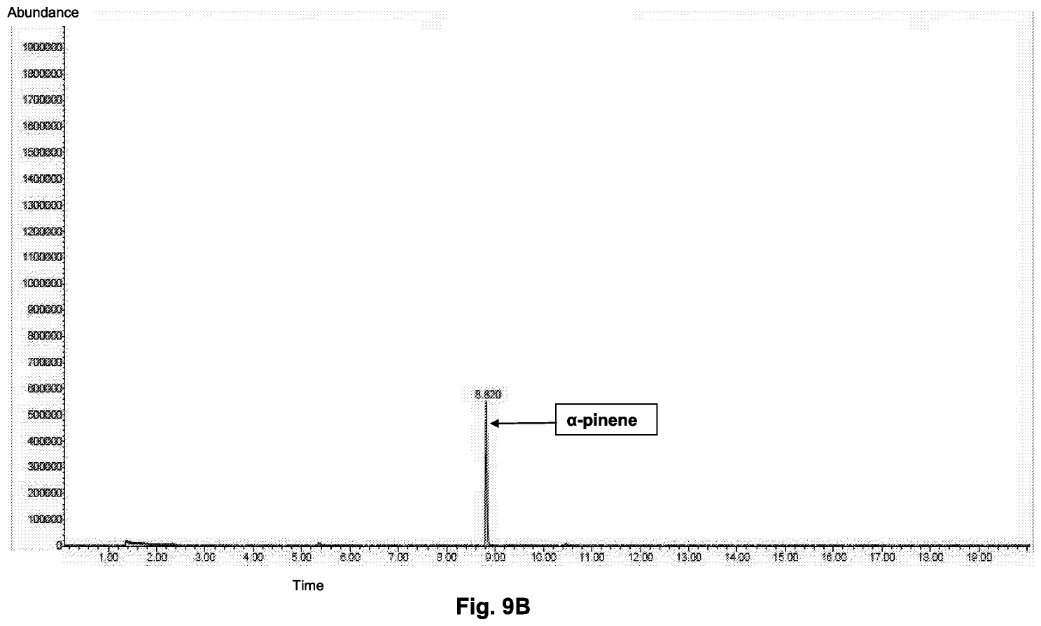

An equal mass of each individual impregnated polymer samples was analysed using headspace and the chromatogram is shown in FIG. 9. FIG. 9 shows HS-SPME-GC-MS chromatogram of the impregnated red film (top) and impregnated polymer beads (bottom). The data suggested that although the two sources of polymers were impregnated using the identical method, it appeared that the red film had released a higher abundance of α-pinene compared to the polymer beads. This greater release of α-pinene may be due to the encapsulation of the α-pinene within the blisters on the impregnated red film material.

Conclusions: These tests have demonstrated that α-pinene can be successfully impregnated into two forms of polymer composition HDT WPL015. It was noted that blisters were formed on the red film material due to the encapsulation of α-pinene; this encapsulation effect had enhanced the abundance of the release of α-pinene from the material compared to the polymer beads which did not have the encapsulation effect.

### Examples—Insect Attractant Release Profiles

Initial observations have indicated that the polymer film of polymer composition HDT WPL015 release the insect attractant α-pinene over a period of at least 3 months, in an amount sufficient to attract pine weevils and/or pine beetles into an insect trap. Therefore an insect lure formed from HDT WPL015 and impregnated with a pinene compound as described above may be effective in a method of controlling insects which affect tree plantations, during a breeding season of said insects.

In summary. The present invention provides a method for impregnating a polymer composition with an active compound or composition using liquid carbon dioxide, in order for the active compound or composition to be later released from the polymer composition gradually over a period of time. The polymer composition may comprise polybutylene succinate and pores and/or cavities into which the active compound or composition can be introduced by the method. The method involves exposing the polymer composition to carbon dioxide and the active compound or composition under increased pressure. The polymer composition may be used to form an article for use in repelling or attracting insects, for example wearable insect repellent articles or lures for insect traps. Polymer compositions suitable for use in the method, and articles comprising said polymer compositions and active compounds or compositions are also provided. A method of attracting or repelling insects is also provided.

### EXAMPLE SET 2—PREPARATION OF POLYMER COMPOSITIONS

Each of the polymer compositions described below in Table 4 were formed as described above for Example Set 1. The type of structure-modifying additive used in each polymer composition is noted in the far right-hand column.

TABLE 4

| Polymer | PBS | PLA | Additive |
|---|---|---|---|
| composition | (wt %) | (wt %) | type - wt % |
| 2.1 | 35 | 45 | Vinnex 2504 - 15 and |
| | | | starch - 5 |
| 2.2 | 30 | 55 | Vinnex 2504 - 15 |
| 2.3 | 19 | 60 | Luzenac talc - 7 and |
| | | | Vinnex 2504 - 14 |
| 2.4 | 10 | 55 | Polycarb 60S - 22 and |
| | | | Vinnex 2504 - 13 |

These polymer compositions were formed into rolls of film as described above for Example Set 1. The films were impregnated with active compounds as described above for Example Set 1.

Polymer composition 2.1 was impregnated with a 1:1:1 mixture of lavandin oil, geranium oil and citriodiol. The film was found to provide a suitable release profile for the application of this polymer composition and active composition for repelling mosquitos and/or horsefly from humans or animals.

Polymer composition 2.2 was impregnated with nootkatone. The film was found to provide a suitable release profile for the application of this polymer composition and active compound composition for repelling ticks from humans or animals.

Polymer composition 2.3 was impregnated with nonanal and octanal. The film was found to provide a suitable release profile for the application of this polymer composition and active composition for attracting bed bugs, for example into a trap.

Polymer composition 2.4 was impregnated with a liquid seaweed fertilizer comprising comprises nitrogen, potassium, phosphate and suitably magnesium, as well as plant sugars, growth hormones and other essential minerals. The film was found to provide a suitable release profile for the application of this polymer composition and active composition for feeding plants such as turf, fruit, vegetables and ornamental plants.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to. For example, “the polymer composition comprises from 30 to 90 wt % PBS” means that 30 to 90 wt % of the polymer composition is provided by PBS.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of impregnating an article with an active compound or composition, wherein the article is formed from a polymer composition comprising polybutylene succinate, the method comprising the steps of:
a) placing the article in a pressurisable vessel,
b) adding carbon dioxide to the pressurisable vessel,
c) increasing the pressure in the pressurisable vessel to above ambient pressure,
d) adding the active compound or composition to the pressurisable vessel,
e) depressurising the reactor and removing the article from the pressurisable vessel.

2. The method of claim 1, wherein in step c) the pressure in the pressurisable vessel is increased to above the critical pressure of carbon dioxide and the temperature in the pressurisable vessel is increased to above the critical temperature of carbon dioxide.

3. The method according to claim 1, wherein the polymer composition comprises polylactic acid.

4. The method according to claim 1, wherein the active compound or composition comprises an essential oil derived from a plant.

5. The method according to claim 1, wherein the active compound or composition is an insect repellent.

6. The method according to claim 1, wherein the active compound or composition comprises lavandin oil, geranium oil and citriodiol.

7. The method according to claim 1, wherein the article is a wearable article for repelling insects from a human or animal.

8. The method according to claim 1, wherein the active compound or composition is an insect attractant.

9. The method according to claim 8, wherein the active compound or composition comprises α-pinene and/or β-pinene.

10. The method according to claim 8, wherein the article is a lure for an insect trap.

11. The method according to claim 1, wherein after step d) and before step e), the pressurisable vessel is kept under the increased pressure of carbon dioxide for at least 10 minutes.

12. A polymer composition comprising polybutylene succinate and a structure-modifying additive.

13. The polymer composition according to claim 12, wherein the structure-modifying additive is selected from any one or more of: polyvinyl acetate, a polysaccharide, calcium carbonate and talc.

14. An article for attracting or repelling insects, wherein the article is formed from a polymer composition comprising polybutylene succinate and wherein the polymer composition is impregnated with an active compound or composition.

15. A method of attracting or repelling insects, the method comprising the steps of:
1) forming an article from a polymer composition comprising polybutylene succinate;
2) impregnating the article with an insect attractant or repellent compound or composition according to the method of claim 1;
3) placing the article at a location where insects are to be attracted to or repelled from.
